(19) United States
(12) Patent Application Publication
(10) Pub. No.: US 2022/0253977 A1
(43) Pub. Date: Aug. 11, 2022

(54) METHOD AND DEVICE OF SUPER-RESOLUTION RECONSTRUCTION, COMPUTER DEVICE AND STORAGE MEDIUM

(71) Applicant: Shenzhen Technology University, Shenzhen (CN)

(72) Inventor: Mengye LYU, Shenzhen (CN)

(21) Appl. No.: 17/402,162

(22) Filed: Aug. 13, 2021

(30) Foreign Application Priority Data
Feb. 5, 2021 (CN) 202110159101.3

(51) Int. Cl. G06T 3/40; G06T 7/40; G06K 9/46; G06K 9/62

(52) U.S. Cl. CPC G06T 3/4053; G06T 7/40; G06K 9/46; G06T 2207/20084; G06T 3/4046; G06T 2207/20221; G06T 2207/20081; G06K 9/6215

(57) ABSTRACT

A method and device of super-resolution reconstruction, a computer device and a storage medium. The method includes: collecting low-resolution image data to be reconstructed; acquiring reference image data satisfying a similarity condition from a pre-established high-resolution image database, and the high-resolution image database being established according to high-resolution image data corresponding to a plurality of different objects; fusing the low-resolution image data and the reference image data, and reconstructing target high-resolution image data corresponding to the low-resolution image data.

### CROSS-REFERENCE TO RELATED APPLICATION

This application claims benefits of Chinese Patent Application No. 202110159101.3, entitled “Method and Device of Super-resolution Reconstruction, Computer Device and Storage Medium”, filed on Feb. 5, 2021, the technical disclosure of which is hereby incorporated by reference in its entirety.

### TECHNICAL FIELD

The present application relates to the field of image processing technology, and in particular, to a method and a device of super-resolution reconstruction, a computer device and a storage medium.

### BACKGROUND

Super-Resolution reconstruction is a process of improving the resolution of the original image data through hardware or software, and obtaining high-resolution image databased on a series of low-resolution image data. The super-resolution reconstruction is widely used in the medical field. For medical images (such as CT, MRI, and ultrasound images), in order to improve efficiency and accuracy of diagnosis, users (doctors or related researchers) may obtain images with higher resolution in a short period of time by means of the super-resolution reconstruction.

In the prior art, during the super-resolution reconstruction, the super-resolution reconstruction model is usually trained by inputting the images to be reconstructed into the super-resolution reconstruction model, to reconstruct the target high-resolution image. This reconstruction method cannot achieve good effects, and often results in an image distortion while increasing the resolution.

### SUMMARY

Based on this, for the above technical problems, it is necessary to provide a method and a device of super-resolution reconstruction, a computer device, and a storage medium, which can effectively avoid an image distortion.

A method of super-resolution reconstruction, includes:

collecting low-resolution image data to be reconstructed,

acquiring reference image data satisfying a similarity condition from a pre-established high-resolution image database, and the high-resolution image database being established according to high-resolution image data corresponding to a plurality of different objects, and

fusing the low-resolution image data and the reference image data, to reconstruct target high-resolution image data corresponding to the low-resolution image data.

In some embodiments, the fusing the low-resolution image data and the reference image data includes:

extracting a textural feature of the low-resolution image data and a textural feature of the reference image data, respectively, to obtain a low-resolution textural feature corresponding to the low-resolution image data and a high-resolution textural feature corresponding to the reference image data;

fusing the low-resolution textural feature and the high-resolution textural feature, to reconstruct the target high-resolution image data corresponding to the low-resolution image data.

In some embodiments, a step of establishing the high-resolution image database includes:

acquiring the high-resolution image data corresponding to the plurality of different objects,

extracting a feature of each high-resolution image data to obtain a high-resolution feature vector corresponding to each high-resolution image data, and

storing each high-resolution image data and a corresponding high-resolution feature vector thereof into the database correspondingly, to establish the high-resolution image database.

In some embodiments, before the acquiring the reference image data satisfying the similarity condition from the pre-established high-resolution image database, the method further includes:

extracting a feature of the low-resolution image data, to obtain the low-resolution feature vector corresponding to the low-resolution image data.

The acquiring the reference image data satisfying the similarity condition from the pre-established high-resolution image database includes:

obtaining the target high-resolution feature vector from the high-resolution image database, wherein a vector distance between the target high-resolution feature vector and the low-resolution feature vector satisfies a distance condition, and determining the high-resolution image data corresponding to the target high-resolution feature vector to be the reference image data.

In some embodiments, after the storing each high-resolution image data and the corresponding high-resolution feature vector thereof into the database correspondingly to establish the high-resolution image database, the method further includes:

clustering each high-resolution feature vector to obtain a plurality of feature vector clusters, each of the feature vector clusters having a corresponding cluster center;

using the cluster center corresponding to each feature vector cluster as an index item and using the high-resolution feature vector in each feature vector cluster as an inverted rank file to establish an inverted rank index.

In some embodiments, the low-resolution image data and the high-resolution image data are both medical image data. The low-resolution image data and the high-resolution image data are any one of two-dimensional data, three-dimensional data, and Fourier space data.

In some embodiments, before the extracting the textural feature of the low-resolution image data and the textural feature of the reference image data respectively, the method further includes:

obtaining a trained machine learning model, the machine learning model comprising a feature extraction layer.

The extracting the textural feature of the low-resolution image data and the textural feature of the reference image data respectively, includes:

inputting the low-resolution image data and the reference image data into the feature extraction layer, and extracting the textural feature of the low-resolution image data and the textural feature of the reference image data respectively in the feature extraction layer.

The fusing the low-resolution textural feature and the high-resolution textural feature and reconstructing the target high-resolution image data corresponding to the low-resolution image data includes:

fusing the low-resolution textural feature and the high-resolution textural feature by means of the machine learning model, and reconstructing the target high-resolution image data corresponding to the low-resolution image data.

In some embodiments, the machine learning model further includes a feature comparison layer and a feature fusion layer. The fusing the low-resolution textural feature and the high-resolution textural feature by means of the machine learning model and reconstructing the target high-resolution image data corresponding to the low-resolution image data includes:

inputting the low-resolution textural feature and the high-resolution textural feature into the feature comparison layer, and comparing the low-resolution textural feature with the high-resolution textural feature in the feature comparison layer to obtain the similarity and a similar feature distribution; and

inputting the low-resolution image data and the similar feature distribution into the feature fusion layer, fusing the similar feature distribution and the low-resolution image data in the feature fusion layer, and reconstructing the target high-resolution image data corresponding to the low-resolution image data.

A device of super-resolution reconstruction, including:

a data collection module, configured to collect low-resolution image data to be reconstructed;

a search module, configured to acquire reference image data satisfying a similarity condition from a pre-established high-resolution image database, the high-resolution image database being established according to high-resolution image data corresponding to a plurality of different objects; and

a fusing module, configured to fuse the low-resolution image data and the reference image data, and reconstruct target high-resolution image data corresponding to the low-resolution image data.

A computer device including a storage and a processor. The storage stores a computer program. When executing the computer program, the processor performs steps of:

collecting low-resolution image data to be reconstructed;

acquiring reference image data satisfying a similarity condition from a pre-established high-resolution image database, and the high-resolution image database being established according to high-resolution image data corresponding to a plurality of different objects;

fusing the low-resolution image data and the reference image data, and reconstructing target high-resolution image data corresponding to the low-resolution image data.

A computer-readable storage medium, having a computer program stored thereon, when executing the computer program, a processor performs steps of:

collecting low-resolution image data to be reconstructed;

acquiring reference image data satisfying a similarity condition from a pre-established high-resolution image database, and the high-resolution image database being established according to high-resolution image data corresponding to a plurality of different objects;

fusing the low-resolution image data and the reference image data, and reconstructing target high-resolution image data corresponding to the low-resolution image data.

The method and the device of super-resolution reconstruction, the computer device, the storage medium obtain the low-resolution image data to be reconstructed, obtain the reference image data satisfying the similarity condition from the pre-established high-resolution image database, fuse the low-resolution image data and the reference image data to reconstruct the target high-resolution image data corresponding to the low-resolution image data. On the one hand, by means of fusion with the reference image, a real high-resolution image data is fused during the reconstruction, and the effect of the reconstructed image is better, thereby effectively avoiding a distortion. On the other hand, the reference image data is obtained from the high-resolution image database based on the similarity, and the high-resolution image data in the high-resolution image database corresponds to different objects, so the reconstruction process is not limited to the same object, thereby expanding a source of the reference image data and enabling the method of super-resolution reconstruction to have a wider application range.

### BRIEF DESCRIPTION OF THE DRAWINGS

FIG. 1 shows an application environment diagram of an embodiment of a method of super-resolution reconstruction;

FIG. 2 is a schematic flowchart of an embodiment of the method of super-resolution reconstruction;

FIG. 3 is a schematic flowchart of an embodiment of steps of establishing a high-resolution image database:

FIG. 4 is a schematic flowchart of another embodiment of the method of super-resolution reconstruction;

FIG. 5 is an overall architecture view of an embodiment of the method of super-resolution reconstruction;

FIG. 6(a) to FIG. 6(e) illustrate effect comparison diagrams of an actual application scenario by means of the method of super-resolution reconstruction of an embodiment;

FIG. 7 is a structural block view illustrating an embodiment of a device of super-resolution reconstruction;

FIG. 8 is a view illustrating an internal structure of an embodiment of a computer device.

### DETAILED DESCRIPTION

In order to make the objectives, technical solutions, and advantages of the present application clearer and better understood, the present application will be further described in detail with reference to the accompanying drawings and embodiments. It should be understood that, the specific embodiments described herein are only for the purpose of illustrating the present application, but not intended to limit the present application.

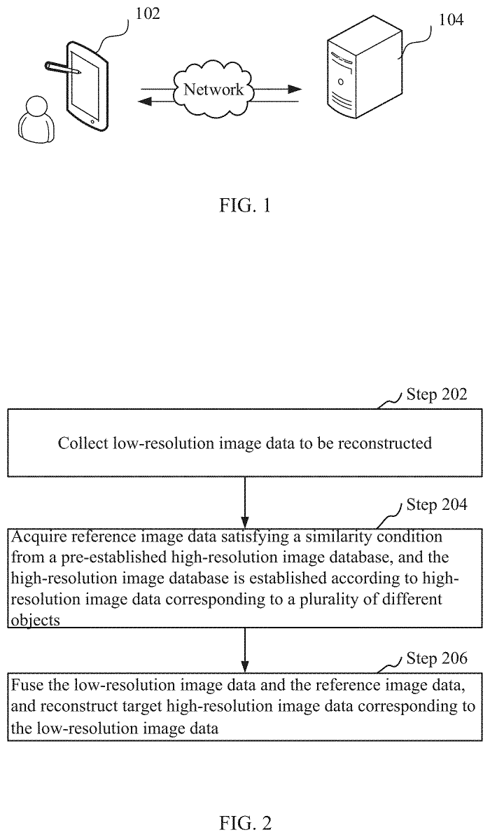

The method of super-resolution reconstruction provided by the present application can be applied to an application scenario shown in FIG. 1. An image collection device 102 communicates with a server 104 via a network. A pre-established high-resolution image database is stored on the server, and is established on the base of high-resolution image data corresponding to different objects. The image collection device 102 collects low-resolution image data and sends it to the server 104. After receiving the low-resolution image data, the server 104 acquires reference image data satisfying a similarity condition from the high-resolution image database, and fuses the low-resolution image data and the reference image data, to reconstruct target high-resolution image data corresponding to the low-resolution image data. The image collection device 102 may be any computer device having image data collection functions. The server 104 may be implemented by an independent server or a server cluster composed of a plurality of servers.

In some embodiments, as shown in FIG. 2, a method of super-resolution reconstruction is provided. Taking the method applied to the server in FIG. 1 for example for illustration, the method includes the following steps.

In Step 202: low-resolution image data to be reconstructed is collected.

The low-resolution image data refers to image data with low resolution. The low resolution means that the resolution is less than a first resolution threshold. Correspondingly, high-resolution image data refers to image data with high resolution, and the high resolution means that the resolution is greater than a second resolution threshold. The first resolution threshold and the second resolution threshold may be set as required, and the second resolution threshold is greater than the first resolution threshold. Therefore, the super-resolution reconstruction may be regarded as a resolution enhancement process.

Specifically, the image collection device may collect low-resolution image data by shooting, scanning, etc., and sends the low-resolution image data to the server, so that the server may obtain the low-resolution image data.

In some embodiments, the low-resolution image data and the high-resolution image data mentioned in the embodiments of the present application may be medical image data, and the medical image data may be a three-dimensional medical image. After the server obtains the three-dimensional medical image, the three-dimensional medical image is segmented and converted into a corresponding two-dimensional image, and then the method of super-resolution reconstruction of the present application is executed, and a final reconstructed image is also a two-dimensional image. In some other embodiments, after the server obtains the three-dimensional medical image, the three-dimensional medical image is used as the low-resolution image to be reconstructed, and the method of super-resolution reconstruction of the present application is executed, and the final reconstructed image is a three-dimensional image.

In other embodiments, the medical image data may be original medical image data, such as K-space data obtained by Magnetic Resonance Imaging (MRI). The K-space is a dual space of a common space by means of Fourier transformation. Therefore, K-space data is also called Fourier space data. After the server obtains low-resolution K-space data, the K-space data is used as the low-resolution image data to be reconstructed. After the method of super-resolution reconstruction of the present application is executed, the high-resolution K-space data is obtained, and the server may further obtain the image by means of Fourier transformation.

In Step 204: reference image data that satisfies a similarity condition is acquired from a pre-established high-resolution image database, and the high-resolution image database is established on the base of the high-resolution image data corresponding to different objects.

The similarity condition refers to a preset condition for searching for similar images. The high-resolution image database is established on the base of the high-resolution image data corresponding to different objects. The different objects and objects corresponding to the low-resolution image data to be reconstructed are usually different respectively. It is understandable that the object mentioned herein refers to a subject of the image data. The subject may be a living body or a non-living body, the living body may be a human body or an animal, and the subject may be the entire living body or the entire non-living body, or may also be part of the living body or part of the non-biological body. For example, if the image data of the present application is medical data, the subject may be a human organ.

Specifically, the server searches for the high-resolution image database, and the similarity between the low-resolution image data to be reconstructed and the high-resolution image data stored in the high-resolution image database is calculated during the search, and according to the calculated result, some high-resolution image data satisfying the similarity condition is selected as reference image data obtained by searching. The reference image data may include one or a plurality pieces of data. The plurality herein refers to a number at least two.

In some embodiments, the similarity condition may be that the similarity is greater than a preset similarity threshold. The server, based on the calculated result of the similarity, may acquire the high-resolution image data, the similarity between which and the low-resolution image data to be reconstructed is greater than the preset similarity threshold, from the preset high-resolution image database to serve as the reference image data. The similarity threshold may be set according to experience.

In other embodiments, the similarity condition may be that when the similarity values each between a high-resolution image data and the low-resolution image data to be reconstructed are sorted according to values, the similarity value selected is ranked top. The server may sort the similarity values according to the calculated result of the similarity, and select the high-resolution image data having the similarity value ranked top as the reference image data. For example, the server may select the high-resolution image data having the greatest similarity value as the reference image data.

In some embodiments, in order to improve search efficiency, the server may perform Product Quantization (PQ) on the high-resolution image data in the high-resolution image database. In some other embodiments, the server may perform the search by means of an algorithm based on Hierarchical Navigable Small World graphs (HNSW).

In Step 206: the low-resolution image data and the reference image data are fused, to reconstruct target high-resolution image data corresponding to the low-resolution image data.

Specifically, the server may obtain similar data in the reference image data, and fuses the similar data and the low-resolution image data to be reconstructed, to reconstruct the target high-resolution image data corresponding to the low-resolution image data. The similar data may be a similar image region or a similar image feature, and the similar image feature may specifically be similar textural feature.

In some embodiments, the fusing the low-resolution image data and the reference image data includes: extracting a textural feature of the low-resolution image data and a textural feature of the reference image data, respectively, to obtain a low-resolution textural feature corresponding to the low-resolution image data and a high-resolution textural feature corresponding to the reference image data; fusing the low-resolution textural feature and the high-resolution textural feature, to reconstruct the target high-resolution image data corresponding to the low-resolution image data.

Specifically, the server extracts the textural feature of the low-resolution image data to obtain the low-resolution textural feature corresponding to the low-resolution image data, and extracts the textural feature of the reference image data to obtain the high-resolution textural feature corresponding to the reference image data. The server further fuses the low-resolution textural feature and the high-resolution textural feature, to reconstruct the target high-resolution image data corresponding to the low-resolution image data.

In some embodiments, the server may extract the textural feature of the low-resolution image data and the textural feature of the reference image data respectively based on neural networks.

In some embodiments, the server may perform the fusion by using a traditional mathematical method. For example, the pixels of the low-resolution textural feature and the pixels of the high-resolution textural feature are weighted and added, to reconstruct the target high-resolution image data corresponding to the low-resolution image data. In other embodiments, the server may fuse the low-resolution textural feature and the high-resolution textural feature by means of the neural networks, to reconstruct the target high-resolution image data corresponding to the low-resolution image data.

In the above method of super-resolution reconstruction, by collecting the low-resolution image data to be reconstructed, the reference image data that satisfies the similarity condition is obtained from the pre-established high-resolution image database. The low-resolution image data and the reference image data are fused to reconstruct the target high-resolution image data corresponding to the low-resolution image data. On the one hand, by means of fusion with the reference image, a real high-resolution image data is fused during the reconstruction, and the effect of the reconstructed image is better, thereby effectively avoiding a distortion. On the other hand, the reference image data is obtained from the high-resolution image database based on the similarity, and the high-resolution image data in the high-resolution image database corresponds to different objects, so the reconstruction process is not limited to the same object, thereby expanding a source of the reference image data and enabling the method of super-resolution reconstruction to have a wider application range.

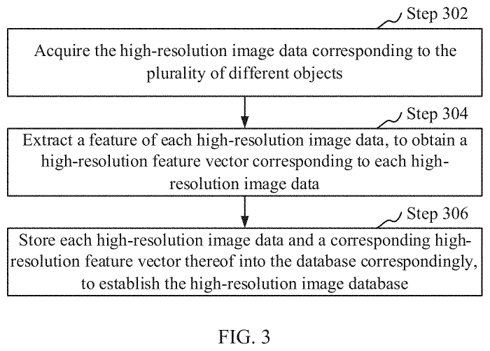

In some embodiments, as shown in FIG. 3, the establishing the high-resolution image database includes following steps.

In Step 302: high-resolution image data corresponding to different objects are acquired.

Specifically, the server may acquire a great number of high-resolution image data corresponding to different objects, and build the high-resolution database based on the acquired high-resolution image data. These high-resolution image data may serve as reference image data for the super-resolution reconstruction. Taking the medical image data as an example of the image data of the present application, the server may acquire a large number of high-resolution image data of different subjects to establish the database.

In Step 304: a feature of each high-resolution image data is extracted to obtain a high-resolution feature vector corresponding to each high-resolution image data.

Specifically, the server may extract the image feature of each high-resolution image data by means of a feature extractor, and vectorizes the extracted image feature, to obtain the high-resolution feature vector corresponding to each high-resolution image data.

In some embodiments, the server may use the GIST feature extractor, and performs vectorization under a 40×40 matrix, to obtain the high-resolution feature vector corresponding to each high-resolution image data.

In some embodiments, the feature extractor in a similar image search module may also use SIFT features, HOG features, or pHASH features. For features of variable length such as SIFT features, they may be further encoded by means of Bag of Words (BoW), Vector of Locally Aggregated Descriptors (VLAD), and Fisher Vector, etc., and are converted into a vector with a fixed length.

In some embodiments, the feature extractor may pre-train convolutional neural networks with image samples based on a convolutional neural network (CNN) model, and then extract an output of a middle layer or a last layer of the networks as an output of the feature extraction. During the training, data enhancement modes, such as a random resolution change, random noise, and a random deformation and flip, etc., may be added.

In Step 306: each high-resolution image data and corresponding high-resolution feature vector thereof are stored in a database correspondingly, to establish the high-resolution image database.

Specifically, after obtaining the high-resolution feature vector corresponding to each high-resolution image data, the server correspondingly stores each high-resolution image data and the corresponding high-resolution feature vector in the database, thereby establishing the high-resolution image database. The server may search the corresponding high-resolution image data from the database according to the high-resolution feature vector.

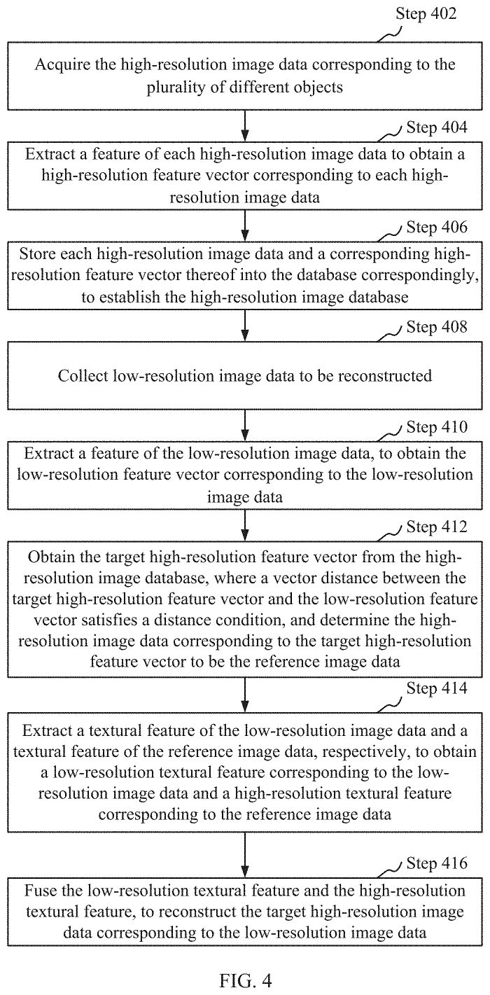

In some embodiments, as shown in FIG. 4, a method of super-resolution reconstruction is provided, and the method includes the following steps.

In Step 402, high-resolution image data corresponding to the plurality of different objects are acquired.

In Step 404, the feature of each high-resolution image data is extracted to obtain a high-resolution feature vector corresponding to each high-resolution image data.

In Step 406, each high-resolution image data and the corresponding high-resolution feature vector are stored in the database correspondingly, to establish the high-resolution image database.

In Step 408, the low-resolution image data to be reconstructed is collected.

In Step 410, a feature of the low-resolution image data is extracted, to obtain the low-resolution feature vector corresponding to the low-resolution image data.

In Step 412, the target high-resolution feature vector is obtained from the high-resolution image database, where a vector distance between the target high-resolution feature vector and the low-resolution feature vector satisfies a distance condition, and the high-resolution image data corresponding to the target high-resolution feature vector is determined to be reference image data.

Where, the vector distance may be a L2-norm distance or a cosine distance.

In some embodiments, the distance condition may be that the vector distance is greater than a preset distance threshold, and the preset distance threshold may be set according to experience. In other embodiments, the distance condition may be that the vector distance is the shortest, and the server may determine that one or more high-resolution feature vectors corresponding to the shortest distance are the target high-resolution feature vectors. For example, the vector distances are sorted from small to large, and the high-resolution feature vectors corresponding to one or more vector distances top ranked are determined to be the target high-resolution feature vectors.

In Step 414: the textural feature of the low-resolution image data and the textural feature of the reference image data are extracted, respectively, to obtain the low-resolution textural feature corresponding to the low-resolution image data and the high-resolution textural feature corresponding to the reference image data.

In Step 416: the low-resolution textural feature and the high-resolution textural feature are fused, to reconstruct the target high-resolution image data corresponding to the low-resolution image data.

In the above-mentioned embodiment, during the establishment of the database, the feature vectors corresponding to the high-resolution image data are correspondingly stored, so that the search may be performed according to the vector distances during the search, thereby improving the search efficiency.

In some embodiments, after the high-resolution image database is established according to the high-resolution feature vectors corresponding to each high-resolution image data, the above method further includes: clustering each high-resolution feature vector to obtain a plurality of feature vector clusters, each of which has a corresponding cluster center; using the cluster center corresponding to each feature vector cluster as an index item, and using the high-resolution feature vector in each feature vector cluster as an inverted rank file, to establish an inverted rank index.

Specifically, the server clusters all high-resolution feature vectors according to the similarity, and after that, a plurality of feature vector clusters will be obtained, thus the high-resolution feature vectors in each feature vector cluster are similar, which means that the similarity is greater than the preset similarity threshold. Each feature vector cluster has a corresponding cluster center. In the process of clustering, an existing clustering algorithm may be used and will not be described repeatedly in the present application.

Further, the server may use each cluster center as the index item, and use the high-resolution feature vectors in each feature vector cluster as the inverted rank file, to establish the inverted rank index. Therefore, when the server searches for the reference image data, the similarity between which and the low-resolution image data to be reconstructed satisfies the similarity condition, and after the feature vector of the low-resolution image data is extracted, the similarity between the feature vector and each cluster center in the index items may be calculated. The index items corresponding to relatively high similarity values are selected, so that the server may only search in the feature vector clusters corresponding to these index items, and not search other feature vector clusters, thereby reducing the search range for data.

In the above embodiments, the high-resolution image data corresponding to different objects is obtained, and the features of each high-resolution image data are extracted, to obtain the high-resolution feature vectors corresponding to each high-resolution image data to establish the high-resolution image database. Further, the inverted rank index is established for the data clusters in the database, so that the search range for data may be reduced during a search, thereby improving the search efficiency and the efficiency of the super-resolution reconstruction.

In some embodiments, before the extracting the textural feature of the low-resolution image data and the textural feature of the reference image data, respectively, the above method of super-resolution reconstruction further includes: acquiring a trained machine learning model. The machine learning model includes a feature extraction layer. The extracting the textural feature of the low-resolution image data and the textural feature of the reference image data respectively includes: inputting the low-resolution image data and the reference image data into the feature extraction layer, and extracting the textural feature of the low-resolution image data and the textural feature of the reference image data respectively in the feature extraction layer. The fusing the low-resolution textural feature and the high-resolution textural feature to reconstruct the target high-resolution image data corresponding to the low-resolution image data includes: fusing the low-resolution textural feature and the high-resolution textural feature by means of the machine learning model, to reconstruct the target high-resolution image data corresponding to the low-resolution image data.

The machine learning model may be a neural network-based model, for example, a transformer neural network, a convolutional neural network, a recurrent neural network, etc.

In some embodiments, the image data of the present application is medical image data. In the process of training the machine learning model, the machine learning model may be pre-trained with non-medical data (such as photos taken by a camera), and then be trained with medical images in specific modalities (CT, MRI, or ultrasound images). During the training, a loss function based on an L1 distance and adversarial loss may be used, and the model parameters are optimized by means of the stochastic gradient descent method till convergence occurs.

Specifically, the server inputs the low-resolution image data and the reference image data into the feature extraction layer, and extracts the textural feature of the low-resolution image data and the textural feature of the reference image data in the feature extraction layer, respectively. After the textural features are extracted, the server may continue to fuse the extracted low-resolution textural feature and the high-resolution textural feature by means of the machine learning model. Finally, the machine learning model outputs the target high-resolution image data to complete the super-resolution reconstruction. It can be understood that the textural feature herein is a textural feature image.

In some embodiments, the machine learning model further includes a feature comparison layer and a feature fusion layer. The fusing the low-resolution textural feature and the high-resolution textural feature by means of the machine learning model, to reconstruct the target high-resolution image data corresponding to the low-resolution image data includes: inputting the low-resolution textural feature and the high-resolution textural feature into the feature comparison layer, and comparing the low-resolution textural feature with the high-resolution textural feature in the feature comparison layer to obtain the similarity and a similar feature distribution; inputting the low-resolution image data and the similar feature distribution into the feature fusion layer, and fusing the similar feature distribution and the low-resolution image data in the feature fusion layer, to reconstruct the target high-resolution image data corresponding to the low-resolution image data.

The similar feature distribution characterizes the location distribution of features among the high-resolution textural features similar to the low-resolution textural features. In some embodiments, the similar feature distribution also characterizes the similarity corresponding to each position distribution.

In some embodiments, the server may compare each pixel in the low-resolution textural feature with each pixel at a corresponding position in the high-resolution textural feature, to obtain a similar feature distribution.

In other embodiments, the server may divide the low-resolution textural feature and the high-resolution textural feature into blocks. For example, the low-resolution textural feature and the high-resolution textural feature may be divided into N (N≥2) blocks, to obtain N low-resolution sub-textural features corresponding to the low-resolution textural feature and N high-resolution sub-textural features corresponding to the high-resolution textural feature, and then each low-resolution sub-textural feature is compared with each high-resolution textural feature at the corresponding position, to obtain the similar feature distribution.

In some embodiments, the feature comparison layer may be a correlation convolutional layer. After extracting the low-resolution textural feature and the high-resolution textural feature by means of the machine learning model, the server continues to input the low-resolution textural feature and the high-resolution textural feature into the correlation convolutional layer, and performs cross-correlation operations on the low-resolution textural feature and the high-resolution textural feature in the correlation convolutional layer, to obtain a related feature image, and the related feature image is the obtained similar feature distribution.

After obtaining the similar feature distribution, the server continues to input the low-resolution image data and the similar feature distribution into the feature fusion layer. Since the textural feature similarity may reflect the location distribution of similar features, then in the feature fusion layer, the server may fuse the similar features in the reference image data with the low-resolution image data based on the similar feature distribution, and reconstruct the target high-resolution image data corresponding to the low-resolution image data.

In some embodiments, the similar feature distribution also characterizes the similarity corresponding to each location distribution. Then, at the feature fusion layer, the server may also determine attention weights based on the similarity corresponding to each location distribution, and the fusion may be performed according to the attention weights. For example, in a specific embodiment, the server may first multiply the similar feature corresponding to each location distribution and a corresponding attention weight, and updates the similar feature of each location distribution with the result of the multiplication performed, and then fuses the updated similar features and the low-resolution image data to be reconstructed. Or the server may first fuse the similar features and the low-resolution image data to be reconstructed, and after the fusion is completed, the fused similar features are multiplied by the attention weights respectively.

It can be understood that, in some embodiments, all the feature extraction layer, the feature comparison layer, and the feature fusion layer may be implemented by one or more layers of neural networks.

In the above embodiment, the low-resolution textural features are compared with the high-resolution textural features, to obtain the similar feature distribution, thus the similar features may be accurately fused during the fusion, and the reconstructed target high-resolution image data is more accurate.

In a specific embodiment, the overall architecture view of the method of super-resolution reconstruction is shown in FIG. 5. Referring to FIG. 5, the server first obtains high-resolution images, vectorizes these images, and then the high-resolution vectors and the high-resolution images are correspondingly stored in the database to establish the high-resolution image database. During the super-resolution reconstruction, after obtaining the low-resolution image to be reconstructed, the server may vectorize the low-resolution image, and then carries out a search of the high-resolution image database according to the obtained low-resolution feature vectors, to obtain at least one high-resolution image similar to the low-resolution image data to be reconstructed to serve as the reference image, and finally the low-resolution image to be reconstructed together with the reference image is input into the trained neural network, and finally the reconstructed target high-resolution image is output.

It can be understood that the neural network in FIG. 5 is configured to perform the fusion in the embodiment of the present application. The neural network may have an alternative mode, such as a Projection Onto Convex Sets (POCS) algorithm, a maximum a posteriori probability (MAP) algorithm, or a Bayesian model algorithm, etc.

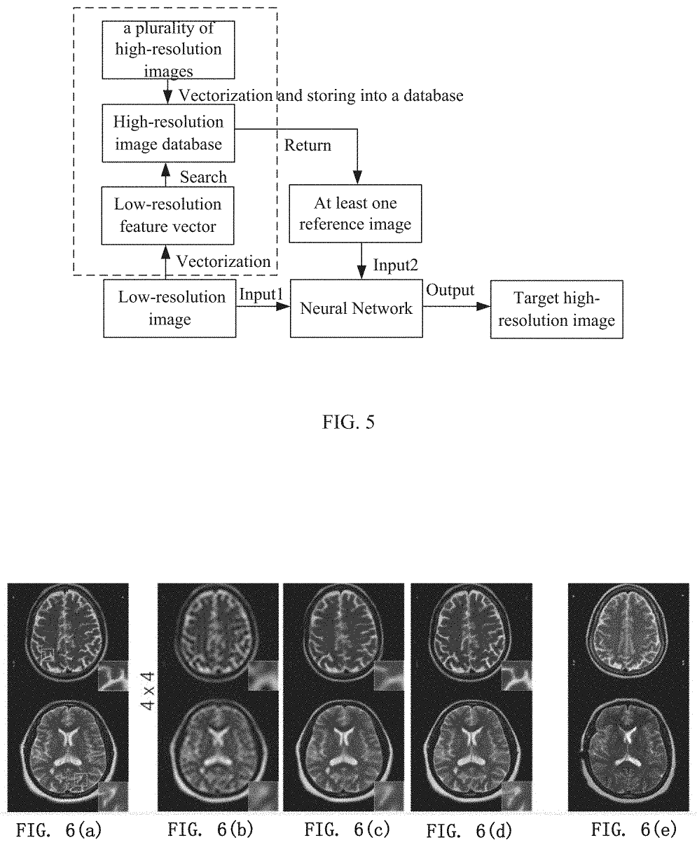

FIG. 6(a) to FIG. 6(e) illustrate effect comparison diagrams of an actual application scenario by means of the method of super-resolution reconstruction of the present application. Where, FIG. 6(a) illustrates ground truth, and FIG. 6(b) and FIG. 6(c) illustrate the test effects displayed under 4×4 times of super-resolution reconstructed by other methods, where FIG. 6(b) shows an interpolation diagram corresponding to the low-resolution image to be reconstructed, and FIG. 6(c) shows the images obtained by the super-resolution reconstruction by the means an enhanced deep super-resolution (EDSR) network model. FIG. 6(d) illustrates the test effects displayed under 4×4 times of super-resolution reconstructed by the method of the super-resolution reconstruction of the present application, and FIG. 6(e) shows the reference images searched from the high-resolution image database. The EDSR network is a super-resolution network scheme that does not use a reference image. A lower right corner of each image shows a partial enlarged view of the position shown in the box. It can be seen that the reconstructed images obtained by the method of super-resolution reconstruction of the present invention are clearer and more accurate, and are proximate to the ground truth.

It should be understood that, although various steps in the flowcharts of FIGS. 2-4 are displayed in a sequence indicated by arrows, these steps are not necessarily executed in the sequence indicated by the arrows. Unless there is a clear description in the present disclosure, there is no strict order for the execution of these steps, and these steps may be executed in other orders. Moreover, at least part of the steps in FIGS. 2-4 may include a plurality of steps or stages. These steps or stages are not necessarily executed at the same time, but may be executed at different time. The execution of these steps or stages is not necessarily performed in sequence, but may be performed in turn or alternately with other steps or with at least part of the steps or stages in other steps.

In some embodiments, as shown in FIG. 7, a device of super-resolution reconstruction 700 is provided, and the device includes following modules.

A data collection module 702 is configured to collect low-resolution image data to be reconstructed.

A search module 704 is configured to acquire reference image data satisfying a similarity condition from a pre-established high-resolution image database. The high-resolution image database is established according to the high-resolution image data corresponding to different objects.

The fusing module 706 is configured to fuse the low-resolution image data and the reference image data, to reconstruct target high-resolution image data corresponding to the low-resolution image data.

In some embodiments, the fusing module 706 is also configured to extract a textural feature of the low-resolution image data and a textural feature of the reference image data, respectively, to obtain a low-resolution textural feature corresponding to the low-resolution image data and a high-resolution textural feature corresponding to the reference image data. The low-resolution textural feature and the high-resolution textural feature are fused, to reconstruct the target high-resolution image data corresponding to the low-resolution image data.

In some embodiments, the device of super-resolution reconstruction further includes a database establishing module. The database establishing module is configured to acquire high-resolution image data corresponding to different objects, extract features from each high-resolution image data to obtain respective high-resolution feature vectors corresponding to each high-resolution image data, and store each high-resolution image data and the respective high-resolution feature vectors in the database to establish the high-resolution image database.

In some embodiments, the device of super-resolution reconstruction further includes a vectorizing module and a search module. The vectorizing module is configured to extract a feature from low-resolution image data to obtain a low-resolution feature vector corresponding to the low-resolution image data. The search module is configured to acquire a target high-resolution feature vector, whose vector distance from the low-resolution feature vector satisfies a distance condition, from the high-resolution image database, and determine the high-resolution image data corresponding to the target high-resolution feature vector to be the reference image data.

In some embodiments, the device of super-resolution reconstruction further includes an index establishing module. The index establishing module is configured to cluster each high-resolution feature vector to obtain a plurality of feature vector clusters, which each have a corresponding cluster center, use the cluster center corresponding to each the vector cluster as an index item, and use the high-resolution feature vector in each feature vector cluster as an inverted file to establish an inverted rank index.

In some embodiments, the low-resolution image data and the high-resolution image data are both medical image data. The low-resolution image data and the high-resolution image data are any one of two-dimensional data, three-dimensional data, and Fourier space data.

In some embodiments, the device of super-resolution reconstruction further includes a model acquiring module for acquiring a trained machine learning model. The machine learning model includes a feature extraction layer. A fusion processing module is also configured to input the low-resolution image data and the reference image data into the feature extraction layer, and extract the textural feature of the low-resolution image data and the textural feature of the reference image data at the feature extraction layer. The low-resolution textural feature and the high-resolution textural feature are fused by the machine learning model, to reconstruct the target high-resolution image data corresponding to the low-resolution image data.

In some embodiments, the machine learning model further includes a feature comparison layer and a feature fusion layer. The fusion processing module is also configured to input the low-resolution textural features and the high-resolution textural features into the feature comparison layer, and at the feature comparison layer, the low-resolution textural feature is compared with the high-resolution textural feature to obtain a similar feature distribution. The low-resolution image data and the similar feature distribution is input into the feature fusion layer, and at the feature fusion layer, the similar feature distribution and the low-resolution image data are fused, to reconstruct the target high-resolution image data corresponding to the low-resolution image data.

For the specific limitation to the device of super-resolution reconstruction, please refer to the above limitation to the method of super-resolution reconstruction, which will not be described repeatedly herein. All modules in the above device of super-resolution reconstruction may be implemented in whole or in part by software, hardware, and a combination of software and hardware. The above modules may be embedded in or independent of the processor of the computer device in a form of hardware, or may be stored in a storage of the computer device in a form of software, so that the processor may call and execute operations corresponding to various modules above.

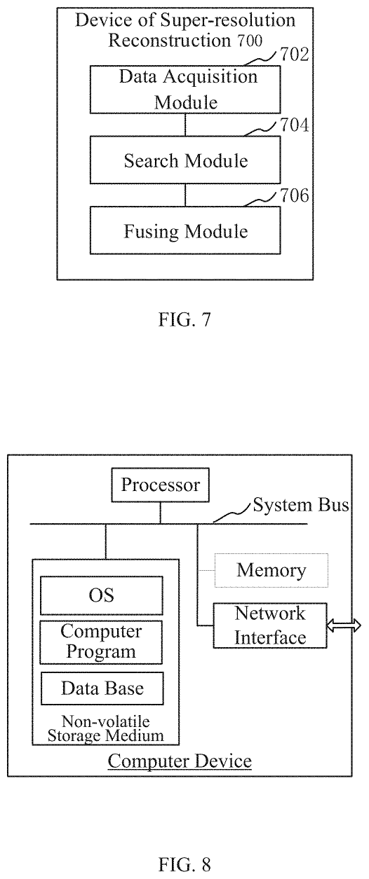

In some embodiments, a computer device is provided. The computer device may be a server, and an internal structure thereof is shown in FIG. 8. The computer device includes a processor, a storage, and a network interface connected with each other by a system bus. Where, the processor of the computer device is configured to provide calculation and control capabilities. The storage of the computer device includes a non-volatile storage medium and a memory. An operating system, a computer program, and a database are stored on the non-volatile storage medium. The memory provides an environment for the operation of the operating system and the computer program stored on the non-volatile storage medium. The database of the computer device is configured to store the high-resolution image data. The network interface of the computer device is configured to communicate with an external terminal by means of a network connection. When executed by the processor, the computer program realizes the method of super-resolution reconstruction.

Those skilled in the art should understand that the structure shown in FIG. 8 is only a block diagram of part of the structure related to the solutions of the present application, but not constitutes a limitation on the computer device, to which the solutions of the present application is applied. The specific computer device may include more or less parts than those shown in the figure, or combine some parts, or have a different arrangement of parts.

In some embodiments, a computer device is provided. The computer device includes a storage and a processor, and a computer program stored on the storage. When executing the computer program, the processor performs the method of super-resolution reconstruction in any one of the foregoing embodiments.

In some embodiments, a computer-readable storage medium is provided, and a computer program is stored on the storage medium. When the computer program is executed by a processor, the method of super-resolution reconstruction in any one of the above embodiments is implemented.

A person of ordinary skill in the art should understand that all or part of the processes in the method of the above embodiments may be implemented by means of a computer program instructing relevant hardware. The computer program may be stored in a non-volatile computer readable storage medium. When the computer program is executed, it may include the procedures of the embodiments of the above method. Where, any reference to the memory, the storage, the database or other medium used in the embodiments provided by the present application may include at least one of non-volatile and volatile memory. Non-volatile memory may include read-only memory (ROM), magnetic tape, floppy disk, flash memory, or optical memory. Volatile memory may include random access memory (RAM) or external cache memory. As an illustration but not a limitation, RAM can be in various forms, such as static random access memory (SRAM) or dynamic random access memory (DRAM), etc.

The technical features of the above embodiments may be combined arbitrarily. In order to make the description concise, not all possible combinations of the technical features of the above embodiments are described. However, as long as there is no contradiction in the combination of these technical features, any combination should be within the range described in this description.

The above examples are only several embodiments of the present application, and the descriptions thereof are more specific and detailed, but they should not be understood to be a limitation on the scope of the present invention. It should be noted that, for those of ordinary skill in the art, several modifications and improvements may be made without departing from the concept of the present application, and all these modifications and improvements fall within the protection scope of the present application. Therefore, the protection scope of the present application shall be subject to the appended claims.

What is claimed is:

1. A method of super-resolution reconstruction, comprising:
collecting low-resolution image data to be reconstructed;
acquiring reference image data satisfying a similarity condition from a pre-established high-resolution image database, and the high-resolution image database being established according to high-resolution image data corresponding to a plurality of different objects;
fusing the low-resolution image data and the reference image data, and reconstructing target high-resolution image data corresponding to the low-resolution image data.

2. The method according to claim 1, wherein the fusing the low-resolution image data and the reference image data comprises:
extracting a textural feature of the low-resolution image data and a textural feature of the reference image data, respectively, and obtaining a low-resolution textural feature corresponding to the low-resolution image data and a high-resolution textural feature corresponding to the reference image data; and
fusing the low-resolution textural feature and the high-resolution textural feature, and reconstructing the target high-resolution image data corresponding to the low-resolution image data.

3. The method according to claim 1, wherein a step of establishing the high-resolution image database comprises:
acquiring the high-resolution image data corresponding to the plurality of different objects;
extracting a feature of each high-resolution image data and obtaining a high-resolution feature vector corresponding to each high-resolution image data; and
storing each high-resolution image data and a corresponding high-resolution feature vector thereof into the database correspondingly, and establishing the high-resolution image database.

4. The method according to claim 3, wherein:
before the acquiring the reference image data satisfying the similarity condition from the pre-established high-resolution image database, the method further comprises:
extracting a feature of the low-resolution image data, and obtaining the low-resolution feature vector corresponding to the low-resolution image data.

5. The method according to claim 3, wherein after the storing each high-resolution image data and the corresponding high-resolution feature vector thereof into the database correspondingly and establishing the high-resolution image database, the method further comprises:
clustering each high-resolution feature vector and obtaining a plurality of feature vector clusters, each of the feature vector clusters having a corresponding cluster center;
using the cluster center corresponding to each feature vector cluster as an index item and using the high-resolution feature vector in each feature vector cluster as an inverted rank file to establish an inverted rank index.

6. The method according to claim 2, wherein,
before the extracting the textural feature of the low-resolution image data and the textural feature of the reference image data respectively, the method further comprises:
obtaining a trained machine learning model, the machine learning model comprising a feature extraction layer.

7. The method according to claim 6, wherein the machine learning model further comprises a feature comparison layer and a feature fusion layer.

8. The method according to claim 7, wherein the fusing the low-resolution textural feature and the high-resolution textural feature by means of the machine learning model and reconstructing the target high-resolution image data corresponding to the low-resolution image data comprises:
inputting the low-resolution textural feature and the high-resolution textural feature into the feature comparison layer, and comparing the low-resolution textural feature with the high-resolution textural feature in the feature comparison layer to obtain the similarity and a similar feature distribution; and
inputting the low-resolution image data and the similar feature distribution into the feature fusion layer, fusing the similar feature distribution and the low-resolution image data in the feature fusion layer, and reconstructing the target high-resolution image data corresponding to the low-resolution image data.

9. The method according to claim 2, wherein a step of establishing the high-resolution image database comprises:
acquiring the high-resolution image data corresponding to the plurality of different objects;
extracting a feature of each high-resolution image data and obtaining a high-resolution feature vector corresponding to each high-resolution image data; and
storing each high-resolution image data and a corresponding high-resolution feature vector thereof into the database correspondingly, and establishing the high-resolution image database.

10. The method according to claim 4, wherein the acquiring the reference image data satisfying the similarity condition from the pre-established high-resolution image database comprises:
obtaining the target high-resolution feature vector from the high-resolution image database, wherein a vector distance between the target high-resolution feature vector and the low-resolution feature vector satisfies a distance condition, and determining the high-resolution image data corresponding to the target high-resolution feature vector to be the reference image data.

11. The method according to claim 6, wherein the extracting the textural feature of the low-resolution image data and the textural feature of the reference image data respectively, comprises:
inputting the low-resolution image data and the reference image data into the feature extraction layer, and extracting the textural feature of the low-resolution image data and the textural feature of the reference image data respectively in the feature extraction layer.

12. The method according to claim 11, wherein the fusing the low-resolution textural feature and the high-resolution textural feature and reconstructing the target high-resolution image data corresponding to the low-resolution image data comprises:
fusing the low-resolution textural feature and the high-resolution textural feature by means of the machine learning model, and reconstructing the target high-resolution image data corresponding to the low-resolution image data.

13. A device of super-resolution reconstruction, comprising:
a data collection module, configured to collect low-resolution image data to be reconstructed;
a search module, configured to acquire reference image data satisfying a similarity condition from a pre-established high-resolution image database, the high-resolution image database being established according to high-resolution image data corresponding to a plurality of different objects; and
a fusing module, configured to fuse the low-resolution image data and the reference image data, and reconstruct target high-resolution image data corresponding to the low-resolution image data.

14. A computer device comprising a storage and a processor, the storage storing a computer program, wherein, when executing the computer program, the processor performs steps of the method of claim 1.

15. A computer-readable storage medium, having a computer program stored thereon, wherein, when executing the computer program, a processor performs steps of the method of claim 1.
